(19) United States
(12) Patent Application Publication
(10) Pub. No.: US 2023/0314620 A1
(43) Pub. Date: Oct. 5, 2023

(54) CHANNEL SELECTION CONTROLLER FOR CALCULATING CORRELATIONS WITH DIFFERENT CONTEXT LENGTHS

(71) Applicant: Samsung Electronics Co., Ltd., Suwon-si (KR)

(72) Inventors: Henry Dennis FALK, Long Beach, CA (US); Di ZHOU, San Jose, CA (US); Sigang QIU, Sunnyvale, CA (US)

(21) Appl. No.: 18/187,512

(22) Filed: Mar. 21, 2023

Related U.S. Application Data
(60) Provisional application No. 63/327,664, filed on Apr. 5, 2022.

(51) Int. Cl. G01S 19/21; G01S 19/25

(52) U.S. Cl. CPC G01S 19/21; G01S 19/256

(57) ABSTRACT

A system and a method are disclosed for calculating correlations with different context lengths. In some embodiments, the system includes: a correlation engine; and a first input sample memory operatively coupled to the correlation engine, the correlation engine including a channel selection controller and being configured, under the control of the channel selection controller: to execute, during a first execution interval, a first channel, the first channel having a first context length; and to execute, during the first execution interval, a second channel, the second channel having a second context length, different from the first context length.

### CROSS-REFERENCE TO RELATED APPLICATION

This application claims the priority benefit under 35 U.S.C. § 119(e) of U.S. Provisional Application No. 63/327,664, filed on Apr. 5, 2022, the disclosure of which is incorporated by reference in its entirety as if fully set forth herein.

### TECHNICAL FIELD

The disclosure generally relates to Global Navigation Satellite System. More particularly, the subject matter disclosed herein relates to improvements to systems and methods for calculating correlations in a Global Navigation Satellite System receiver.

### SUMMARY

The estimation of the position of a Global Navigation Satellite System receiver may involve calculating correlations between bit sequences and received signals. This calculating may be computationally burdensome. The calculating may involve performing multiple correlations between received signals and bit sequences. Each such correlation may be performed by a respective channel, each channel being configured to process a different hypothesis as to a particular GNSS constellation, satellite, carrier frequency (e.g., L1, L2, or L5), and time of arrival and Doppler frequency offset of the signal.

To solve this problem, correlation engines capable of performing multiple correlations, one channel at a time, may be employed. Each correlation engine may be a digital circuit specifically designed to perform correlations at high rates, so that a plurality of channels sharing a correlation engine may be able to process a plurality of signals at the rates at which they are received. Each time a channel runs on a correlation engine, the correlation engine may process a quantity of data referred to as the context length of the channel.

One issue with the above approach is that such correlation engines may require that all of the channels have the same context length.

To overcome these issues, systems and methods are described herein for executing, in one correlation engine, a plurality of channels having a plurality of different respective context lengths.

The above approaches improve on previous methods because it results in a more flexible system.

According to an embodiment of the present disclosure, there is provided a system, including: a correlation engine; and a first input sample memory operatively coupled to the correlation engine, the correlation engine including a channel selection controller and being configured, under the control of the channel selection controller: to execute, during a first execution interval, a first channel, the first channel having a first context length; and to execute, during the first execution interval, a second channel, the second channel having a second context length, different from the first context length.

In some embodiments, the system further includes a second input sample memory operatively coupled to the correlation engine.

In some embodiments, the first channel is configured to process samples from the first input sample memory and the second channel is configured to process samples from the second input sample memory.

In some embodiments, the system further includes a Global Navigation Satellite System front end processor, configured to store samples in the first input sample memory and in the second input sample memory.

In some embodiments, the channel selection controller is configured to select a third channel, to be executed after the second channel, the selecting being based on a code phase of the third channel.

In some embodiments, the selecting is further based on a size of an input sample memory, of the first input sample memory and the second input sample memory, associated with the third channel.

In some embodiments, the selecting is further based on a context length of the third channel.

In some embodiments: the correlation engine further includes a sequencer; and the channel selection controller is further configured to forward information for the third channel to the sequencer.

In some embodiments, the channel selection controller is configured to select, during the execution of the third channel, a fourth channel to be executed after the third channel.

In some embodiments, the correlation engine is further configured to execute, during the first execution interval, a third channel, the third channel having a third context length, different from the first context length and different from the second context length.

According to an embodiment of the present disclosure, there is provided a method, including: executing, by a correlation engine operatively coupled to a first input sample memory, during a first execution interval, a first channel, the first channel having a first context length; and executing, by the correlation engine, during the first execution interval, a second channel, the second channel having a second context length, different from the first context length.

In some embodiments, the correlation engine is further operatively coupled to a second input sample memory.

In some embodiments, the first channel is configured to process samples from the first input sample memory and the second channel is configured to process samples from the second input sample memory.

In some embodiments, the correlation engine is further operatively coupled to a Global Navigation Satellite System front end processor, configured to store samples in the first input sample memory and in the second input sample memory.

In some embodiments, the method further includes selecting, by a channel selection controller of the correlation engine, a third channel, to be executed after the second channel, the selecting being based on a code phase of the third channel.

In some embodiments, the selecting is further based on a size of an input sample memory, of the first input sample memory and the second input sample memory, associated with the third channel.

In some embodiments, the selecting is further based on a context length of the third channel.

In some embodiments, the channel selection controller is configured to select, during the execution of the third channel, a fourth channel to be executed after the third channel.

In some embodiments, the correlation engine is further configured to execute, during the first execution interval, a third channel, the third channel having a third context length, different from the first context length and different from the second context length.

According to an embodiment of the present disclosure, there is provided a system, including: means for correlating; and a first input sample memory operatively coupled to the means for correlating, the means for correlating being configured: to execute, during a first execution interval, a first channel, the first channel having a first context length; and to execute, during the first execution interval, a second channel, the second channel having a second context length, different from the first context length.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of a portion of a Global Navigation Satellite System receiver, according to an embodiment;

FIG. 2 is a block diagram of a portion of a Global Navigation Satellite System receiver, according to an embodiment;

FIG. 3 is a channel sequence diagram, according to an embodiment;

FIG. 4 is a channel sequence diagram, according to an embodiment;

FIG. 5 is a block diagram of a portion of a Global Navigation Satellite System receiver, according to an embodiment;

FIG. 6A is a block diagram of a channel selection controller, according to an embodiment;

FIG. 6B is an illustration of a hardware usage efficiency criterion, according to an embodiment;

FIG. 6C is an illustration of an overflow criterion, according to an embodiment; and

FIG. 7 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth. As used herein, a “correlation engine” is a circuit (e.g., a state machine that is not a stored-program computer) configured to calculate correlations between bit sequences and received signals. As used herein, a “channel selection controller” is a circuit that controls the order in which channels are executed by a correlation engine.

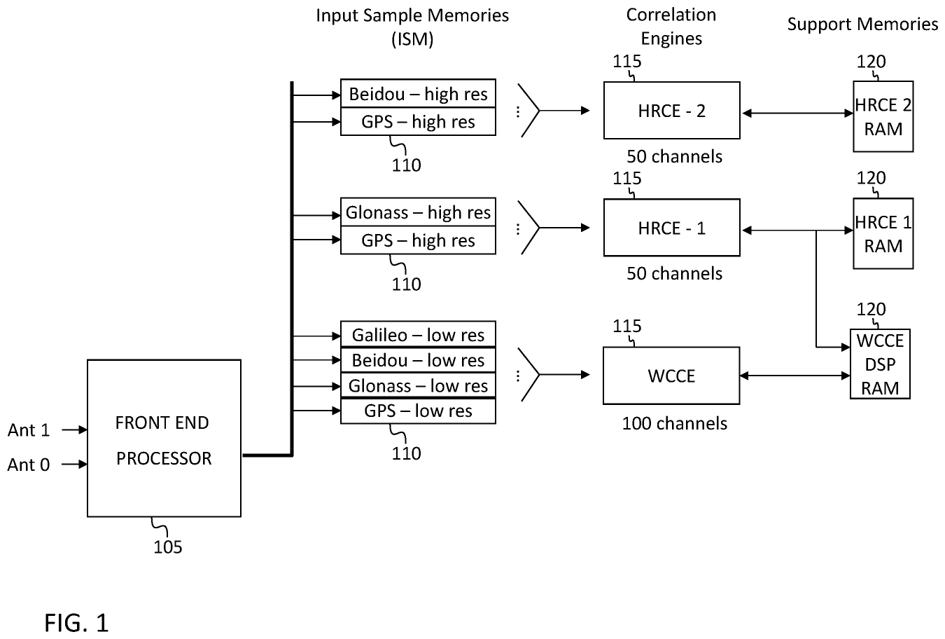

Referring to FIG. 1, in a Global Navigation Satellite System (GNSS), the GNSS signal processing system may include a front end processor 105 that takes input signals from one or more antennas preprocessed by Radio Frequency (RF) analog logic to create one or more streams of baseband digital data, received by the front end processor 105 at the Ant0 and Ant1 inputs. This data is processed by the front end processor 105, which performs such functions as frequency mixing, continuous wave (CW) interference detection and removal, filtering, and quantization. The resultant outputs of the front end processor 105 are dedicated streams of data for the different signals contained in the RF input. These created data streams may be for different GNSS constellations such as GPS, Galileo, Global Navigation Satellite System (Glonass), and Beidou. The created streams are from different carrier frequencies (L1, L2, and L5 for example), at different sample rates (2fx, 4fx, 8fx, 12fx, 20fx, and 24 fx, for example, where fx is a fundamental sampling frequency) and at different data densities (1 bit in-phase (I) and 1 bit quadrature (Q) vs. 2 bit I and 2 bit Q vs. 4 bit I and 4 bit Q, for example).

The different data streams may then be stored in random access memory (RAM), in circular buffers referred to as Input Sample Memories (ISMs) 110. The ISMs are read by the correlation engines 115 (e.g., by one or more Widely Configurable Correlation Engines (WCCEs), or one or more high resolution correlation engines (HRCEs)) in which the acquisition and tracking of specific satellite signals are performed. The correlation engines may operate in a channelized fashion in which the correlation engine hardware (HW) is time multiplexed to allow each channel to process a different hypothesis as to particular GNSS constellation, satellite, carrier frequency (e.g., L1, L2, or L5), and time of arrival and Doppler frequency offset of the signal. The correlation engines may be configurable to process an array of different types of signal transmitted by the different GNSSs. The WCCE correlation engine may cover a wide range of conditions required to acquire and then track a satellite signal from strong open sky signals to very weak obstructed and multi-pathed signals. The high resolution correlation engines (HRCE) may process and track signals with greater resolution and at higher sample rate. The calculating of a correlation corresponding to (e.g., defined by the parameters of) a channel may be referred to herein as “executing” the channel (by a correlation engine or by a correlation logic circuit of the correlation engine).

As each correlation engine cycles through its respective channels, it accesses data from the ISM associated with each channel. For example, a WCCE channel that is acquiring a GPS signal may be reading data from the GPS low resolution (low res) ISM. A channel tracking a Glonass signal may use the Glonass low resolution ISM. An HRCE-2 channel tracking Beidou may be reading from a Beidou high resolution (high res) ISM. The ISMs may be configurable in size and as to what data stream is stored in them. This allows flexibility in the types of satellite signals the correlation engines can support.

Each correlation engine may have its own dedicated support random access memory (RAM) 120. These memories may be configurable in region allocation to store, for each channel, dedicated channel records (containing channel state and parameters for each channel) and correlation data. The support memories 120 and the Input Sample Memories 110 may be implemented as physically separate memories (as illustrated), or as different regions within one or more shared memory chips. One or more of the ISMs 110 and one or more of the support memories 120 may be regions of a shared RAM.

The correlation engines may run at a much higher rate than the ISMs 110 are being filled with data. This allows the channelized operation of the correlation engines 115. Each channel is associated with a correlation engine 115, and when the channel starts executing (in the correlation engine 115) it takes control of the hardware of the correlation engine 115 with which it is associated. Each interval of time during which a channel executes (before ceding control of the correlation engine 115 to the next channel) may be referred to as a “context”. A set of channel records may be stored in the support memory 120 of each correlation engine 115. These channel records may include various parameters controlling the execution of the channel, including, when the channel is not executing, the final state at the end of the channel's last executed context. A sequencer initializes the channel to the final state of the channel at the end of its last context and then allows the engine to process a programmed amount of data from the channel's assigned ISM 110. The new final state of the channel is then stored back in the channel record and the next channel begins to execute. All the active channels are processed one after the other and then the cycle repeats, beginning with the first channel. The channels cycle around fast enough so that all channels can capture all the data from their respective ISMs 110. A set of contiguous contexts executed by a correlation engine 115 may be referred to as an “execution interval”. Between execution intervals, the correlation engine 115 may be stopped, reconfigured (e.g., with a different set of channels) and restarted. The arrow from HRCE 1 RAM to WCCE RAM represents a dump of correlations that were processed in the HRCE and HRCE RAM to the digital signal processor (DSP) RAM for software to retrieve. The DSP RAM may be much larger than the HRCE RAM and a convenient place for storage until software can retrieve it.

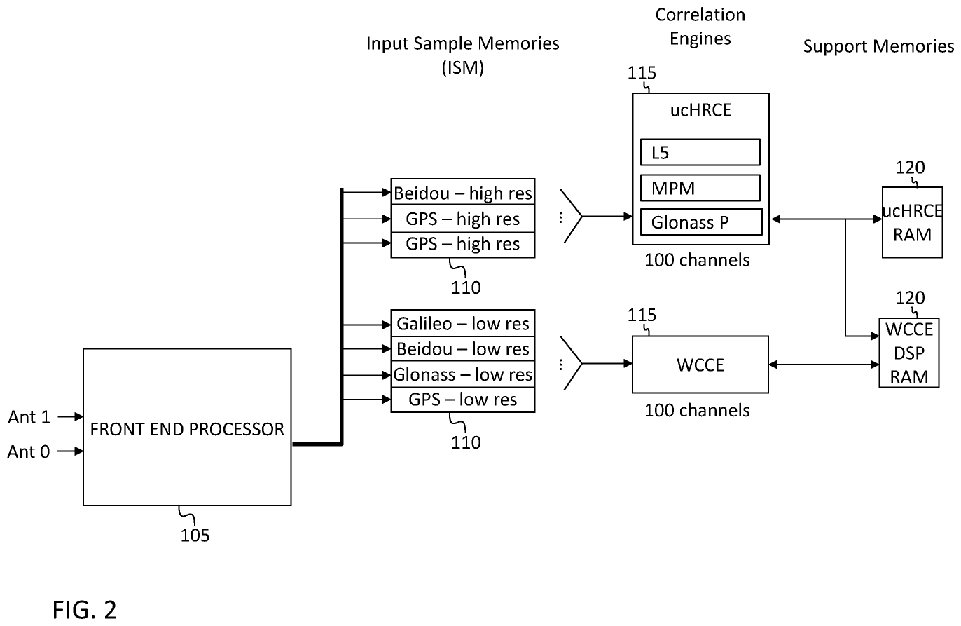

FIG. 2 shows a similar system, in which the HRCEs have been combined into a single more efficient universal configurable High Resolution Correlator engine (ucHRCE) that may include L5 correlators, multipath mitigation (MPM) correlators, and Glonass P correlators (where Glonass P is Glonass L1 secured frequency (SF) that uses a P-Code rather than a coarse acquisition (CA)-code), and that may have modes to support the different types of processing the individual HRCEs of FIG. 1 may support. As in the system of FIG. 1, one or more of the ISMs 110 and one or more of the support memories 120 may be regions of a shared RAM.

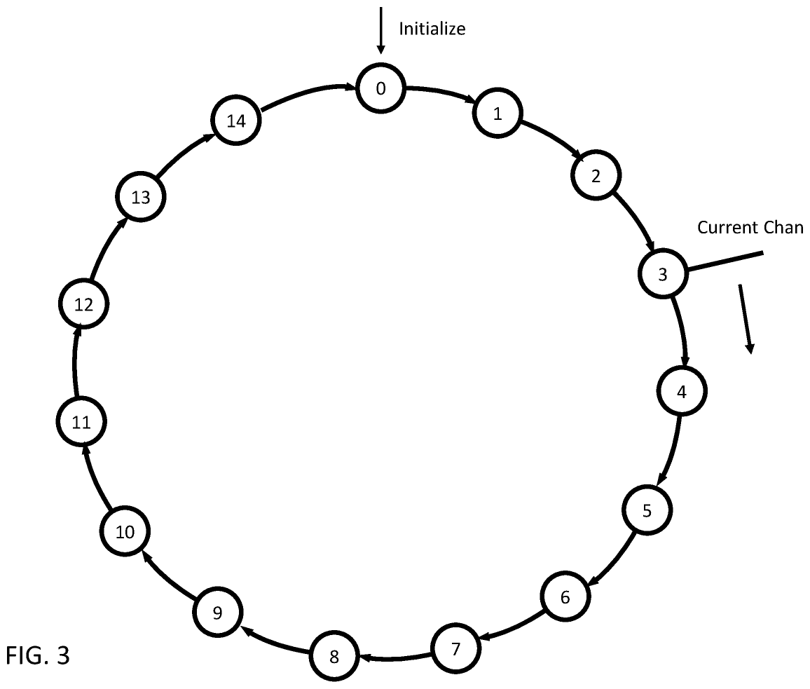

FIG. 3 illustrates channel sequencing, in some embodiments. Channels may be organized in a linked list fashion, in which part of the channel record is an address that points to the next channel that is to execute. Thus, the channel zero channel record may contain a pointer to channel one, the channel one channel record may contain a pointer to channel two, and so forth all the way up to the final channel (e.g., 14 in FIG. 3) which has a pointer in its channel record pointing back to channel zero. The channels are executed in order, from channel zero to the final channel, and then the sequence repeats. When a number of channels are read from the same ISM 110, the starting point in the ISM 110 may be offset a small amount from channel to channel so that although each channel consumes the same amount of data (which may be referred to as a context length) each channel's range of data processed in a context is a little later than the channel before it. As such, the final channel's starting point may be almost a full context length later than the last starting point of channel zero. In addition, because of Doppler and because of coder epoch alignment (time at which the nominal first “chip” of the pseudonoise (PN) sequence occurs, data modulated on top of the PN sequence is aligned with the coder epoch) each channel can have a starting code phase for the context that has an offset in a one millisecond range. So although the next channel may be nominally slightly offset in time from the previous channel, that offset also has a +/−½ msec range imposed on it. This adds a level of complexity to the time line management and benefits from the flexibility afforded by some embodiments disclosed herein.

The starting time at which a channel reads data from an ISM 110 may be referred to as the channel's code phase. Code phase represents the processing point in time for a channel and is defined relative to a real time acquisition counter (acqcnt) such as acqcnt16fx, which is a roughly 16 megahertz (MHz) fixed frequency reference acquisition counter for the system. For example, the code phase of a channel, when the channel is not executing, may be the value that the acquisition counter had (or will have) when the sample that the channel will process when it next starts up was saved to the ISM 110. The system may have several reference counters used for the ISMs to support the different sample rates, such as acqcnt16fx, acqcnt12fx, acqcnt20fx, and acqcnt24fx. ISMs that store data that is at a 2fx, 4fx, or 8fx rate may all use the acqcnt16fx counter as reference because they have a binary relationship.

Thus, when a channel begins executing in a correlation engine 115, the channel may (i) start reading data from an ISM 110 starting at the code phase saved in the channel record from the last context of the channel, (ii) process one context's worth of data from the ISM 110, and (iii) save the initial code phase plus the channel's context length back to the channel record as the final code phase.

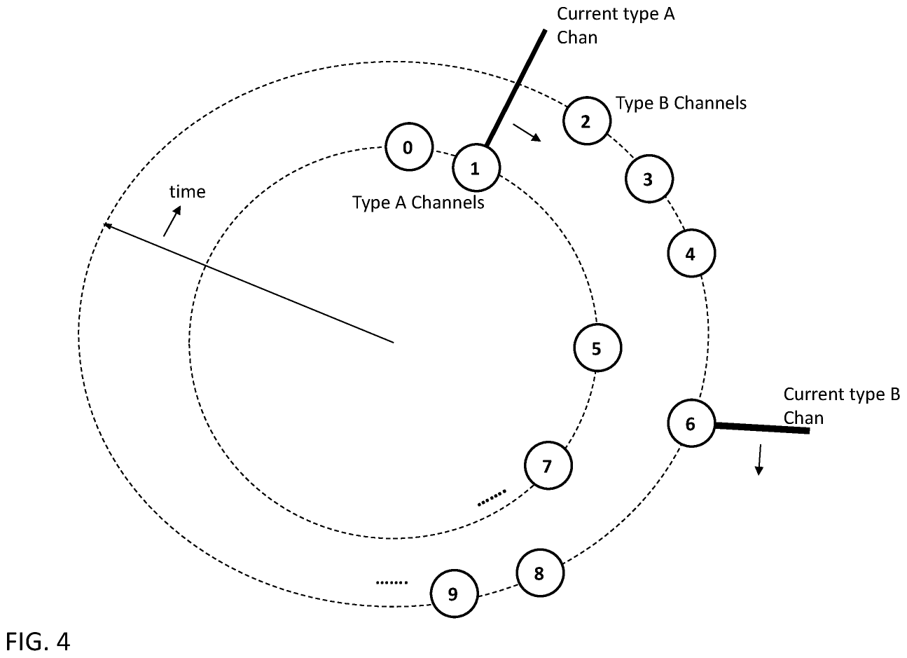

FIG. 4 shows a channel diagram in which channels of type A and type B (having different respective context lengths) are broken into two circular loops. The channel pointers in the channel record may, as in the embodiment of FIG. 3, point in a sequential fashion (e.g., with channel 0 pointing to channel 1, which points to channel 2, etc.). Type A channels may all be executed in increasing channel number order and type B channels may also be executed in increasing channel number order. In the embodiment of FIG. 4, the channels may be configured to execute with different frequencies, e.g., the type B channels may execute more frequently than the type A channels. The embodiment of FIG. 4 may be employed for improved efficiency when a first set of channels (e.g., the channels of type A) has a fixed context length (e.g., all of the channels of type A have the same context length) and shares a first ISM 110, and a second set of channels (e.g., the channels of type B) has a fixed context length (e.g., all of the channels of type B have the same context length, different from the context length of the channels of type A) and shares second ISM 110. The ISMs 110 may have different acquisition counters which maintain the respective write positions.

In the embodiment of FIG. 4, the type A channels will go around the type A loop once every contextLengthA (where contextLengthA is the context length of the channels of type A) and the type B channels will go around the type B loop once every contextLengthB (where contextLengthB is the context length of the channels of type B).

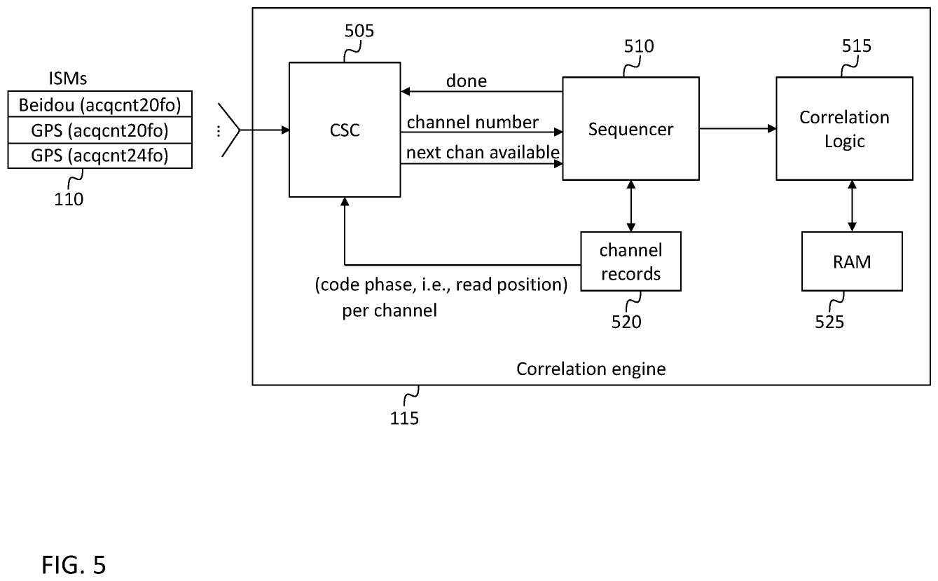

FIG. 5 shows the control structure of a correlation engine 115 (or a means for correlating) (e.g., an HRCE, a WCCE, or a ucHRCE), which is configured to allow execution of channels with different context lengths. The following description explains the operation of the system in a configuration in which channels of two different channel types are executing; the system and method may readily be generalized to configurations in which channels of more than two different types are executing. The correlation engine 115 includes (or is connected to) a channel selection controller (CSC) 505, a sequencer 510, a correlation logic circuit 515, one or more ISMs 110, channel record storage 520 and correlation logic RAM 525. The channel record storage 520 and correlation logic RAM 525 may be within the support memory 120 of the correlation engine 115.

The channel selection controller 505 starts off operation by going through an algorithm to select a channel to execute. The channel selection controller 505 provides the engine sequencer 510 with a channel number (or channel address in channel record memory) and a start command indicating that the next channel is available (by sending the “next chan available” signal). The sequencer 510 then initializes the correlation logic circuit 515 to the initial state for the channel (which is the final state of the channel from its last context) and the correlation logic circuit 515 then processes one context worth of data from the ISM 110. For the WCCE, for example, this may be 7 milliseconds (msec) of data. For the HRCE, for example, it may be 50 microseconds (usec) of data. The correlator engine performs the correlation function at a higher processing clock rate than the sampling rate at which the ISM is filled, so it may, for example, take the WCCE on the order of 70 usec real time to process 7 msec of data from an ISM 110. This example processing rate would allow a total of around 100 channels to operate on the engine. When the correlation logic completes processing one context of data from an ISM 110 (7 msec for example) the sequencer 510 saves the final state of the correlation logic back to the channel record (to prepare for the next context of the channel) and sends a done signal to the channel selection controller 505.

While the correlation logic circuit 515 executes one context of one channel (e.g., correlates one context worth of ISM data), the channel selection controller 505 selects the next channel to be executed. Thus by the time the channel selection controller 505 receives a done signal from the sequencer 510, the correlation logic circuit 515 has selected the next channel for the correlation logic circuit 515 to execute. The channel selection controller 505 gives the sequencer 510 the new next channel number and a start command and the sequencer 510 proceeds to control the correlation logic circuit 515 as with the previously executed channel.

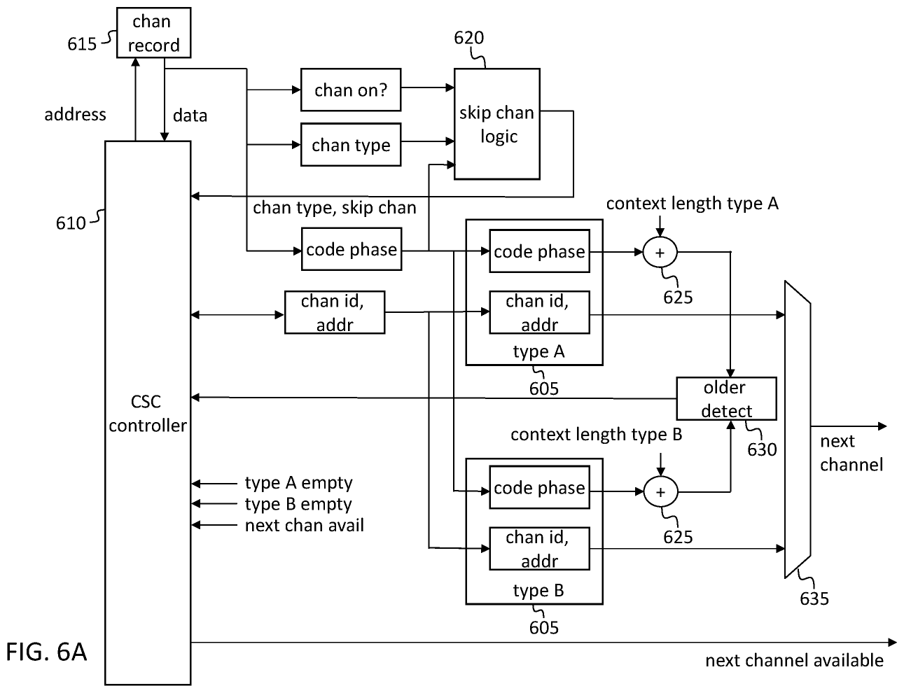

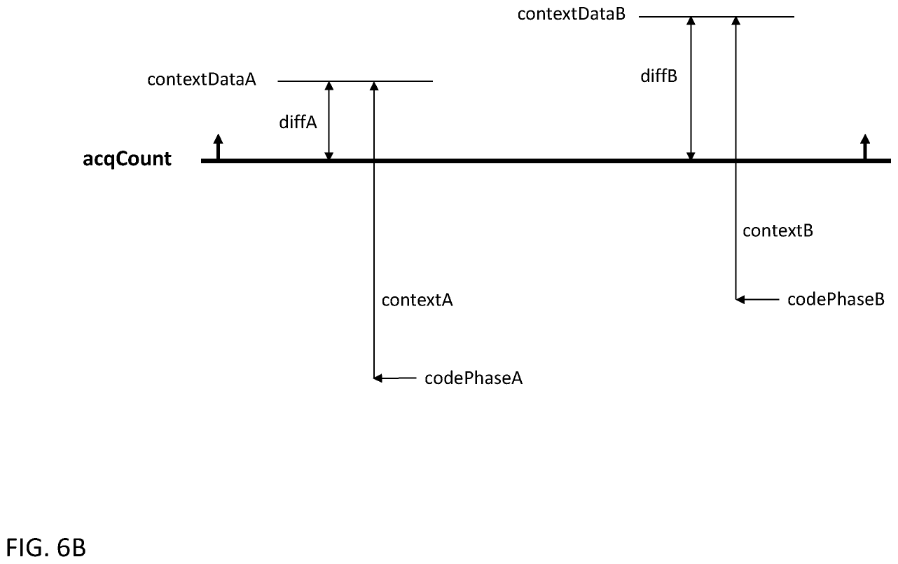

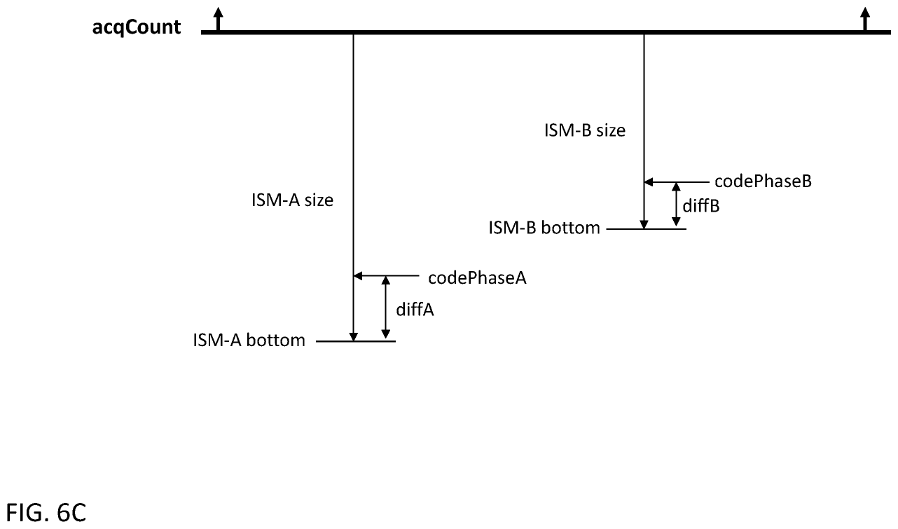

FIG. 6 shows a block diagram of the channel selection controller 505. The channel selection controller 505 may have several control and state registers. Registers referred to as typeAen and typeBen may control whether to allow execution of type A channels and type B channels, respectively. Registers referred to as nextChanTypeA and nextChanTypeB may store the channel numbers of the type A and B channels that the channel selection controller 505 has identified as the next channel of each type to be executed. Registers referred to as typeAEmpty and typeBEmpty indicate whether a next channel of type A has been found and whether a next channel of type B has been found, respectively. A register referred to as the nextChanAv register generates the start signal fed to the sequencer 510.

In operation, the channel selection controller 505 searches for the next channel of the type that is currently executing (e.g., searching for the next channel of type A when a channel of type A is executing, and searching for the next channel of type B when a channel of type B is executing) (at startup, the channel selection controller 505 may search for one of each). These next channels are stored in channel information registers 605, one for type A and one for type B. Each of the channel information registers may contain the code phase, the channel identifier (chan id) and the address, in memory, of the channel record, for the channel.

When the channel selection controller 505 sends, to the sequencer 510, the channel identifier and the address, in memory, of the channel record, for a channel to be executed, the channel information register 605 is marked empty (e.g., the typeAEmpty register or the typeBEmpty register is set). The channel selection controller 505 then identifies a channel of the appropriate type (e.g., of type A if the type A channel information register 605 is empty) to be executed next, stores the channel identifier and the address of this channel in the channel information register 605, and clears the corresponding register of the typeAEmpty register or the typeBEmpty register. The channels associated with the correlation engine 115 may (as in the case described above, in the discussion of FIG. 3, in which all such channels have the same context length) be stored in a linked list, containing both type A and type B channels. To identify the next channel to be executed, of a particular type (e.g., of type A), the channel selection controller 505 may search the list for the next channel, of the type (e.g., of Type A), that is turned on (e.g., enabled). The channel selection controller 505 may include a CSC controller 610 that may perform this search, accessing the channel records 615, and using a skip channel logic circuit 620 to determine whether the next channel in the list is to be skipped or whether instead the information for the channel is to be stored in the channel information register 605. In some embodiments the type A and type B channels are stored in respective separate linked lists.

When the two channel information registers 605 are full, the channel selection controller 505 may select one of them based on which is “older”, e.g., based on which channel has the smaller value of code phase+context length (which may be calculated for each by a respective adder 625). An “older detect” circuit 630 may compare the two sums and send the result of the comparison to the CSC controller 610, which may control an output multiplexer 635 to send the channel identifier and channel address of the selected channel (e.g., from the channel information register 605 corresponding to the older channel) to the sequencer 510. In such an embodiment the selection of the channel (e.g., the determination of which channel is older) is based on the code phase of the channel and on the context length of the channel. The comparison, which may be referred to as a hardware usage efficiency criterion (which may be used to obtain efficient usage of the hardware), is illustrated in FIG. 6B. In FIG. 6B, contextDataA=codePhaseA+contextA, contextDataB=codePhaseB+contextB, and:

diffA=(codePhaseA+contextA)−acqCount, and

diffB=(codePhaseB+contextB)−acqCount.

In the above equations, diffA and diffB are indications of the age of the channel; when diffA<diffB, a typeA channel may be used; otherwise a typeB channel may be used. An equivalent form of this criterion may be written:

Diff=(codePhaseA+contextLengthA)−(codePhaseB+contextLengthB);

when Diff<0 a type A channel may be used, and otherwise a type B channel may be used. This method may have the effect of selecting the channel with the earlier (smaller) value of contextData (e.g., of contextDataA and contextDataB). Each channel may start execution at the stored initial code phase of the channel and process one context's worth of data. If the complete data needed by the channel on its context is already in the ISM 110 (e.g., if the fill in point to the ISM 110 (the acquisition counter) is at least (code phase+context length) when the channel begins to execute), then the correlation logic circuit 515 will not need to wait for data to be stored in the ISM 110. Otherwise, the channel may stall (e.g., the correlation logic circuit 515 may wait, idle) after starting execution until all (or at least some) of the data needed for the context has been filled into the ISM 110. In some embodiments the channel which has the smaller value of the quantity code phase−(acquisition counter value−ISM size (in samples)) is considered the older channel; in such an embodiment the selection of the channel is based on the code phase of the channel and on the size of the ISM. This criterion, which is illustrated in FIG. 6C, may be referred to as an overflow criterion (which may be used to prevent an overflow condition). For example, diffA and diffB as defined in the equations below may be indications of the age of the channel:

diffA=codePhaseA−(acqCount−ISM-A size), and

diffB=codePhaseB−(acqCount−ISM-B size).

When diffA<diffB, a typeA channel may be used; otherwise a typeB channel may be used. This method may have the effect of selecting the channel that is closer to overflow.

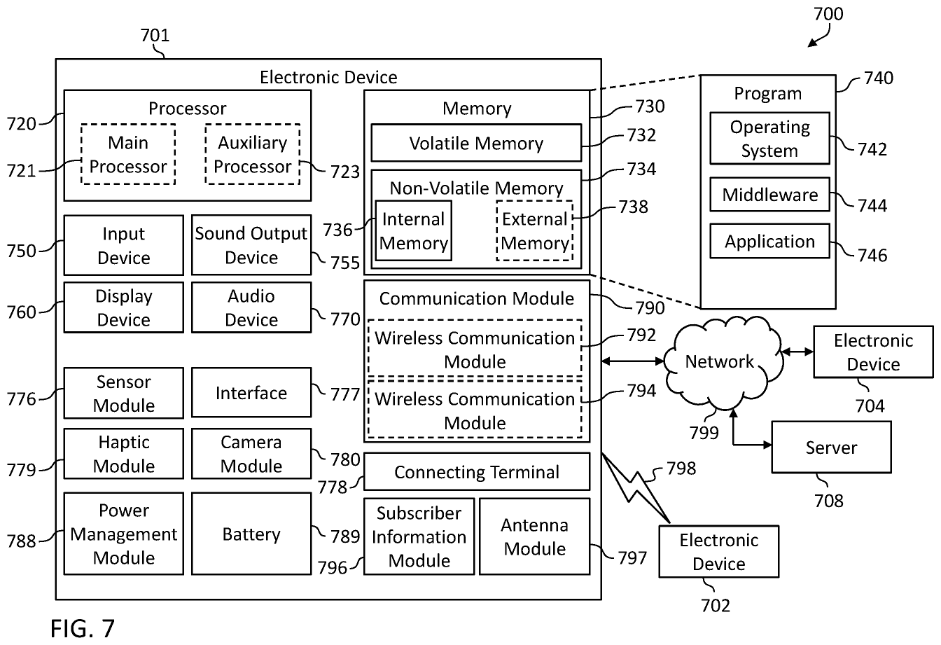

FIG. 7 is a block diagram of an electronic device in a network environment 700, according to an embodiment. Such a device, or portions of such a device, may be used to implement systems described herein.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 740, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 794. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 746 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A system, comprising:
a correlation engine; and
a first input sample memory operatively coupled to the correlation engine,
the correlation engine comprising a channel selection controller and being configured, under the control of the channel selection controller:
to execute, during a first execution interval, a first channel, the first channel having a first context length; and
to execute, during the first execution interval, a second channel, the second channel having a second context length, different from the first context length.

2. The system of claim 1, further comprising a second input sample memory operatively coupled to the correlation engine.

3. The system of claim 2, wherein the first channel is configured to process samples from the first input sample memory and the second channel is configured to process samples from the second input sample memory.

4. The system of claim 2, further comprising a Global Navigation Satellite System front end processor, configured to store samples in the first input sample memory and in the second input sample memory.

5. The system of claim 2, wherein the channel selection controller is configured to select a third channel, to be executed after the second channel, the selecting being based on a code phase of the third channel.

6. The system of claim 5, wherein the selecting is further based on a size of an input sample memory, of the first input sample memory and the second input sample memory, associated with the third channel.

7. The system of claim 5, wherein the selecting is further based on a context length of the third channel.

8. The system of claim 5, wherein:
the correlation engine further comprises a sequencer; and
the channel selection controller is further configured to forward information for the third channel to the sequencer.

9. The system of claim 5, wherein the channel selection controller is configured to select, during the execution of the third channel, a fourth channel to be executed after the third channel.

10. The system of claim 1, wherein the correlation engine is further configured to execute, during the first execution interval, a third channel, the third channel having a third context length, different from the first context length and different from the second context length.

11. A method, comprising:
executing, by a correlation engine operatively coupled to a first input sample memory, during a first execution interval, a first channel, the first channel having a first context length; and
executing, by the correlation engine, during the first execution interval, a second channel, the second channel having a second context length, different from the first context length.

12. The method of claim 11, wherein the correlation engine is further operatively coupled to a second input sample memory.

13. The method of claim 12, wherein the first channel is configured to process samples from the first input sample memory and the second channel is configured to process samples from the second input sample memory.

14. The method of claim 12, wherein the correlation engine is further operatively coupled to a Global Navigation Satellite System front end processor, configured to store samples in the first input sample memory and in the second input sample memory.

15. The method of claim 12, further comprising selecting, by a channel selection controller of the correlation engine, a third channel, to be executed after the second channel, the selecting being based on a code phase of the third channel.

16. The method of claim 15, wherein the selecting is further based on a size of an input sample memory, of the first input sample memory and the second input sample memory, associated with the third channel.

17. The method of claim 15, wherein the selecting is further based on a context length of the third channel.

18. The method of claim 15, wherein the channel selection controller is configured to select, during the execution of the third channel, a fourth channel to be executed after the third channel.

19. The method of claim 11, wherein the correlation engine is further configured to execute, during the first execution interval, a third channel, the third channel having a third context length, different from the first context length and different from the second context length.

20. A system, comprising:
means for correlating; and
a first input sample memory operatively coupled to the means for correlating,
the means for correlating being configured:
to execute, during a first execution interval, a first channel, the first channel having a first context length; and
to execute, during the first execution interval, a second channel, the second channel having a second context length, different from the first context length.
